(19) United States
(12) Patent Application Publication
(10) Pub. No.: US 2024/0277000 A1
(43) Pub. Date: Aug. 22, 2024

(54) VEGETABLE FAT COMPOSITION FOR EDIBLE APPLICATIONS WITH IMPROVED TASTE AND MELTDOWN

(71) Applicant: AAK AB (PUBL), Malmö (SE)

(72) Inventor: Morten Daugaard ANDERSEN, Aarhus (DK)

(21) Appl. No.: 18/568,395

(22) PCT Filed: Jun. 17, 2022
(86) PCT No.: PCT/SE2022/050595

§ 371 Date: Dec. 8, 2023

(30) Foreign Application Priority Data
Jun. 18, 2021 (SE) 2150786-8

(51) Int. Cl. A23D 9/00; A21D 2/16; A21D 13/28; A21D 13/38; A23G 1/38; A23G 3/40; A23G 3/54

(52) U.S. Cl. CPC A23D 9/00; A21D 2/165; A21D 13/28; A21D 13/38; A23G 1/38; A23G 3/40; A23G 3/54

(57) ABSTRACT

The present invention relates to a vegetable fat composition for edible applications wherein, in said vegetable fat composition, the sum of saturated fatty acids is in the range from 93.0% to 99.0% by weight; sum of saturated C12:0 fatty acids is in the range from 40.0% to 60.0% by weight; sum of mono-unsaturated C18:1 fatty acids is in the range from 1.0% to 6.0% by weight; and sum of mono-unsaturated C40:1 to C48:1 triglycerides is in the range from 1.0% to 5.5% by weight. The invention also relates to uses of the vegetable fat composition in coating or enrobing for bakery, confectionary and/or moulding applications, such as chocolate or chocolate-like coating, as well as an edible application product comprising the vegetable fat composition.

### TECHNICAL FIELD OF THE INVENTION

The present invention relates to a vegetable fat composition for edible applications. The invention also relates to uses of the vegetable fat composition in coating or enrobing for bakery, confectionery and/or moulding applications, such as chocolate or chocolate-like coating, as well as an edible application product comprising the vegetable fat composition.

### BACKGROUND OF THE INVENTION

Non-temper, fast crystallizing compounds, known as cocoa butter substitutes (CBS) generally have the disadvantages of low cocoa butter tolerance. This means that fast crystallizing compounds are best suited for cocoa powder recipes only, in order to avoid undesired short shelf life due to rapid bloom formation. One standard high-quality CBS is based on fully hydrogenated palm kernel stearin (FH PKS) e.g. a FH PKS having an iodine value of 7 (FH PKS IV 7) which results in fast setting compound with fast melting characteristics.

However, a FH PKS can be deemed too hard and somewhat brittle in initial bite and may be perceived as having a slightly waxy meltdown as compared to chocolate. Therefore, a CBS with sensory perception (hardness, brittleness, and meltdown) closer to chocolate is of relevance to the confectionery industry.

Accordingly, the main object of the invention is to provide a non-temper vegetable fat composition, which has an improved overall sensory perception.

Yet another object is to provide a number of applications for such vegetable fat compositions.

### SUMMARY OF THE INVENTION

The present invention relates to a vegetable fat composition for edible applications, wherein in said vegetable fat composition the:
sum of saturated fatty acids is in the range from 93.0% to 99.0% by weight;
sum of saturated C12:0 fatty acids is in the range from 40.0% to 60.0% by weight;
sum of mono-unsaturated C18:1 fatty acids is in the range from 1.0% to 6.0% by weight; and
sum of mono-unsaturated C40:1 to C48:1 triglycerides is in the range from 1.0% to 5.5% by weight.

The vegetable fat composition for edible applications of the present invention will have an improved overall sensory perception over existing non-temper vegetable fat solutions and enables the production of an edible application product that has an improved overall sensory perception over other edible application products using existing non-temper vegetable fat solutions.

The present invention also relates to the use of the vegetable fat composition as disclosed herein in coating or enrobing for bakery, confectionery, and/or moulding applications, such as chocolate and chocolate-like coatings.

The present invention also relates to the use of the vegetable fat composition as disclosed herein in fillings, such as bakery fillings and confectionery fillings.

Further, the present invention also relates to an edible application product comprising the vegetable fat composition according to the present disclosure.

### Definitions

As used herein, the term “vegetable” shall be understood as originating from a plant or a single cell organism. Thus, vegetable fat or vegetable triglycerides are still to be understood as vegetable fat or vegetable triglycerides if all the fatty acids used to obtain said triglyceride or fat is of plant or single cell organism origin.

Saturated fatty acids comprise of chains of carbon atoms joined by single bonds, with the maximum number of hydrogen atoms attached to each carbon atom in the chain. Unsaturated fatty acids comprise of chains of carbon atoms joined by single bonds and varying numbers of double bonds, which do not have their full quota of hydrogen atoms attached. An unsaturated fatty acid can exist in two forms, the cis form and the trans form. A double bond may exhibit one of two possible configurations: trans or cis. In trans configuration (a trans fatty acid), the carbon chain extends from opposite sides of the double bond, whereas, in cis configuration (a cis fatty acid), the carbon chain extends from the same side of the double bond.

By using the nomenclature CX means that the fatty acid comprises X carbon atoms, e.g. a C14 fatty acid has 14 carbon atoms while a C8 fatty acid has 8 carbon atoms.

By using the nomenclature CX:Y means that the fatty acid comprises X carbon atoms and Y double bonds, e.g. a C14:0 fatty acid has 14 carbon atoms and 0 double bonds while a C18:1 fatty acid has 18 carbon atoms and 1 double bond.

By mono-unsaturated C40:1 to C48:1 triglycerides is meant that the triglyceride has a total of between 40 to 48 carbon atoms and only one double bond split between the three fatty acid chains in the three sn-positions. For example a triglyceride having a C14:0 fatty acid in the sn-1 and in the sn-3 position and a C18:1 fatty acid in the sn-2 position will be a mono-unsaturated C46:1 triglyceride.

In general, triglycerides use a “sn” notation, which stands for stereospecific numbering. In a Fischer projection of a natural L-glycerol derivative, the secondary hydroxyl group is shown to the left of C-2; the carbon atom above this then becomes C-1 and that below becomes C-3. The prefix ‘sn’ is placed before the stem name of the compound.

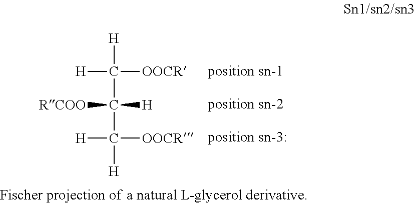

By vegetable fat component is meant a vegetable fat originating from a plant or a single cell organism. The vegetable fat component can e.g. be selected from the group of palm kernel oil, coconut oil, high lauric rapeseed oil, or a blend thereof, and/or fractions thereof, or an interesterified, and/or hydrogenated version of palm kernel oil, coconut oil, high lauric rapeseed oil, or a blend thereof, and/or fractions thereof.

Palm kernel oil can be fractionated to produce palm kernel stearin. Hence, by palm kernel oil or fractions thereof is meant palm kernel oil or a fraction of palm kernel oil such as palm kernel stearin.

As used herein, “%” or “percentage” relates to weight percentage i.e. wt. % or wt.-% if nothing else is indicated.

As used herein, “oil” and “fat” are used interchangeably, unless otherwise specified.

As used herein, “vegetable oil” and “vegetable fat” are used interchangeably, unless otherwise specified.

As used herein the term “single cell oil” shall mean oil from oleaginous microorganisms which are species of yeasts, molds (fungal), bacteria and microalgae. These single cell oils are produced intracellular and in most cases during the stationary growth phase under specific growth conditions (e.g. under nitrogen limitation with simultaneous excess of a carbon source). Examples of oleaginous microorganisms are, but not limited to, Mortierella alpineea, Yarrowia lipolytica, Schizochytrium, Nannochloropsis, Chlorella, Crypthecodinium cohnii, Shewanella.

As used herein “cocoa butter substitute”, CBS, is intended to mean an edible fat having a triglyceride composition very different to cocoa butter. Most cocoa butter substitutes are based on lauric fats, i.e. fats that contain a high amount of lauric acids in their fatty acid composition. Cocoa butter substitutes are only mixable with cocoa butter in small ratios. Furthermore, cocoa butter substitutes are non-temper fat compositions so in contrast to chocolate, cocoa butter substitute based compounds do not need to undergo a treatment at different temperatures, known as tempering, prior to molding, coating, or enrobing, in order to obtain a final product with acceptable form stability and/or shelf life.

As used herein “taste preference” means a combination of hardness, snap, meltdown, waxiness, flavor release, bitterness, and cocoa taste and is in the examples herein compared to a standard high-quality CBS like FH PKS IV 7.

As used herein “improved meltdown” means an SFC profile closer to the melting profile for standard cocoa butter (e.g. West African CB) as compared to the melting profile for a standard CBS like FH PKS IV 7.

As used herein “edible” is something that is suitable for use as food or as part of a food product, such as a dairy or confectionary product.

For products and methods in the confectionery areas, reference is made to “Chocolate, Cocoa and Confectionery”, B. W. Minifie, Aspen Publishers Inc., 3. Edition 1999.

By a chocolate or chocolate-like product is meant a product, which at least is experienced by the consumer as chocolate or as a confectionery product having sensorial attributes common with chocolate, such as e.g. melting profile, taste etc. Some chocolate comprises cocoa butter, typically in substantial amounts, where some chocolate-like product may be produced with a low amount of or even without cocoa butter, e.g. by replacing the cocoa butter with a cocoa butter equivalent, cocoa butter substitute, etc. In addition, many chocolate or chocolate-like products comprise cocoa powder or cocoa mass, although some chocolate or chocolate-like products, such as typical white chocolates, may be produced without cocoa powder, but e.g. drawing its chocolate taste from cocoa butter. Depending on the country and/or region there may be various restrictions on which products may be marketed as chocolate.

The term “comprising” or “to comprise” is to be interpreted as specifying the presence of the stated parts, steps, features, or components, but does not exclude the presence of one of more additional parts, steps, features, or components.

As used herein, the term “and/or” is intended to mean the combined (“and”) and the exclusive (“or”) use, i.e. “A and/or B” is intended to mean “A alone, or B alone, or A and B together”.

### DETAILED DESCRIPTION OF THE INVENTION

The invention relates to a vegetable fat composition for edible applications, wherein in said vegetable fat composition the:
sum of saturated fatty acids is in the range from 93.0% to 99.0% by weight;
sum of saturated C12:0 fatty acids is in the range from 40.0% to 60.0% by weight;
sum of mono-unsaturated C18:1 fatty acids is in the range from 1.0% to 6.0% by weight; and
sum of mono-unsaturated C40:1 to C48:1 triglycerides is in the range from 1.0% to 5.5% by weight.

The vegetable fat composition for edible applications of the present invention will have an improved overall sensory perception.

The vegetable fat composition for edible applications of the present invention has improved taste preference compared to a standard high-quality CBS product (e.g. FH PKS IV 7). The vegetable fat composition also has improved meltdown compared to a standard high-quality CBS (e.g. FH PKS IV 7). These added benefits of the vegetable fat composition compared to a standard CBS product, will have a value in the marked and will differentiate from the existing solutions on the marked.

These two parameters, improved taste preference and improved meltdown, are interconnected. A very important factor in the perception of taste of a food product is flavour release, which is dependent on the meltdown (i.e. the SFC profile). The vegetable fat composition as disclosed herein has an optimized relation between flavour release and meltdown.

FH PKS (fully hydrogenated palm kernel stearin) like FH PKS IV 7 (fully hydrogenated palm kernel stearin with an Iodine value of 7) is a harder solution, more brittle and have a worse meltdown than cocoa butter.

In addition, the vegetable fat composition of the present invention has the same shelf life expectancy as a standard CBS like FH PKS IV 7.

An advantage of the vegetable fat composition of the present invention is also that the edible application compound will have an improved overall sensory perception due to the use of the vegetable fat composition of the present disclosure compared to if a standard high-quality CBS product was used.

The benefit for the producer of such edible application compounds is an overall sensory perception due to the improved taste preference and improved meltdown of the vegetable fat composition used in the edible application compound.

In one or more embodiments, the sum of saturated fatty acids is in the range from 93.5% to 99.0% by weight, such as from 93.5% to 98.5% by weight, such as from 93.5% to 98.0% by weight, or is in the range from 94.0% to 99.0% by weight.

In one or more embodiments, the sum of mono-unsaturated C18:1 fatty acids is in the range from 1.5% to 6.0% by weight, such as from 2.0% to 6.0% by weight, or is in the range from 1.0% to 5.5% by weight, such as from 1.0% to 5.0% by weight.

In one or more embodiments, the sum of mono-unsaturated C18:1 fatty acids is in the range from 2.5% to 6.0% by weight, such as from 3.0% to 6.0% by weight. In one or more embodiments, the sum of mono-unsaturated C18:1 fatty acids is in the range from 1.0% to 4.5% by weight.

In one or more embodiments, the sum of mono-unsaturated C40:1 to C48:1 triglycerides is in the range from 1.5% to 5.5% by weight

In one or more embodiments, the sum of mono-unsaturated C40:1 to C48:1 triglycerides is in the range from 2.0% to 5.5% by weight, such as in the range from 2.5% to 5.5% by weight, such as in the range from 3.0% to 5.5% by weight, or is in the range from 1.0% to 5.0% by weight, such as in the range from 1.0% to 4.5% by weight.

In one or more embodiments, the sum of mono-unsaturated C40:1 to C48:1 triglycerides is the sum of mono-unsaturated C40:1 triglycerides+C42:1 triglycerides+C44:1 triglycerides+C46:1 triglycerides+C48:1 triglycerides.

In one or more embodiments, the iodine value (IV) of the vegetable fat composition is in the range from 1.0 to 6.5, such as from 1.5 to 6.5, such as from 1.5 to 6.0, such as from 2.0 to 6.0, or such as from 2.0 to 5.8.

In one or more embodiments, the vegetable fat composing comprises at least two vegetable fat components selected from the group consisting of palm kernel oil, coconut oil, high lauric rapeseed oil, or a blend thereof, and/or fractions thereof, or an interesterified, and/or hydrogenated version of palm kernel oil, coconut oil, high lauric rapeseed oil, or a blend thereof, and/or fractions thereof.

In one or more embodiments, the vegetable fat composition comprises at least two vegetable fat components, wherein at least one is selected from fully hydrogenated palm kernel stearin and at least one is selected from the group consisting of palm kernel oil, coconut oil, high lauric rapeseed oil, or a blend thereof, and/or fractions thereof, or an interesterified, and/or hydrogenated version of palm kernel oil, coconut oil, high lauric rapeseed oil, or a blend thereof, and/or fractions thereof.

In one or more embodiments, the vegetable fat composition comprises at least two vegetable fat components, wherein at least one is selected from fully hydrogenated palm kernel stearin and at least one is selected from the group consisting of palm kernel oil, coconut oil, high lauric rapeseed oil, or a blend thereof, and/or fractions thereof.

In one or more embodiments, the vegetable fat composition comprises at least two vegetable fat components, wherein at least one is selected from fully hydrogenated palm kernel stearin and at least one is selected from the group consisting of palm kernel oil or a fraction of palm kernel oil.

In one embodiment the fraction of palm kernel oil is palm kernel stearin.

In one or more embodiments, the vegetable fat composition consist of two vegetable fat components. Hence, in one or more embodiments, the vegetable fat composition consist of fully hydrogenated palm kernel stearin and one other vegetable fat component selected from the group consisting of palm kernel oil, coconut oil, high lauric rapeseed oil, or a blend thereof, and/or fractions thereof, or an interesterified, and/or hydrogenated version of palm kernel oil, coconut oil, high lauric rapeseed oil, or a blend thereof, and/or fractions thereof.

In one or more embodiments, the vegetable fat composition consist of fully hydrogenated palm kernel stearin and one other vegetable fat component selected from the group consisting of palm kernel oil, coconut oil, high lauric rapeseed oil, or a blend thereof, and/or fractions thereof.

In one or more embodiments, the vegetable fat composition consist of fully hydrogenated palm kernel stearin and one other vegetable fat component selected from the group consisting of palm kernel oil or a fraction of palm kernel oil.

In one embodiment the fraction of palm kernel oil is palm kernel stearin.

In one or more embodiments, the vegetable fat composition only contains fat components obtained from palm kernel.

In one or more embodiments, the vegetable fat components are originating from naturally occurring vegetable fats.

In one or more embodiments, the vegetable fat composition is not originating from a single cell organism.

In one or more embodiments, the vegetable fat mixture is a Cocoa Butter Substitute (CBS). The CBS will have a sensory perception (hardness, brittleness, and meltdown) closer to chocolate than a standard high-quality CBS. A standard high-quality CBS may be based on fully hydrogenated PKS e.g. a FH PKS IV 7, which results in fast setting compound with fast melting characteristics. However, a FH PKS, like FH PKS IV 7, can be deemed too hard and somewhat brittle in initial bite as compared to chocolate.

In one or more embodiments, the sum of saturated C8:0 to C10:0 fatty acids is in the range from 4% to 6% by weight in the vegetable fat composition.

In one or more embodiments, the sum of saturated C14:0 fatty acids is in the range from 10% to 30% by weight in the vegetable fat composition, such as from 15% to 25%, or such as from 17% to 23%.

In one or more embodiments, the sum of saturated C12:0 to C14:0 fatty acids is at least 50% by weight in the vegetable fat composition, such as at least 55% by weight, or such as at least 60% by weight.

In one or more embodiments, the sum of saturated C16:0 to C18:0 fatty acids is at least 10% by weight in the vegetable fat composition.

In one or more embodiments, the solid fat content of the vegetable fat composition at 20° C. is above 70, such as above 75, such as above 80, or such as above 83. The solid fat content (SFC) was measured according to IUPAC 2.150a.

In one or more embodiments, the solid fat content of the vegetable fat composition at 40° C. is less than 2.5, such as less than 2.0, such as less than 1.5, such as less than 1.0, or such as less than 0.5. The solid fat content (SFC) was measured according to IUPAC 2.150a.

Solid fat content (SFC) is a measure of the percentage of fat in crystalline (solid) phase to total fat (the remainder being in liquid phase) across a temperature gradient.

Also disclosed herein is the use of the vegetable fat composition according to the present disclosure in fillings, such as bakery fillings and confectionery fillings.

Also disclosed herein is the use of the vegetable fat composition according to the present disclosure in coating or enrobing for bakery, confectionery, and/or moulding applications.

Also disclosed herein is the use of the vegetable fat composition according to the present disclosure for chocolate and chocolate-like coatings.

The present invention also discloses an edible application product comprising the vegetable fat composition according to the present disclosure. The edible application compound will have an improved overall sensory perception due to the use of the vegetable fat composition of the present disclosure compared to if a standard high quality CBS product was used.

The benefit for the producer of such edible application compounds is an improved overall sensory perception due to the improved taste preference and improved meltdown of the vegetable fat composition used in the edible application compound.

The edible application product is a non-temper product, which has improved taste preference compared to an edible application product using a standard CBS product (e.g. FH PKS IV 7). The edible application product also has improved meltdown compared to an edible application product using a standard CBS (e.g. FH PKS IV 7).

In addition, the edible application product has the same shelf life expectancy as an edible application product using a standard CBS (e.g. FH PKS IV 7).

In one or more embodiments, the edible application is a bakery product, a dairy product, a chocolate product, and/or a chocolate-like product.

In one or more embodiments, the edible application product is a coating or enrobing product for bakery, confectionery, and/or moulding applications.

In one or more embodiments, the edible application product is for moulding applications.

In one or more embodiments, the edible application product is a chocolate product or a chocolate-like product for moulding applications.

In one or more embodiments, the edible application product is a filling, such as a bakery filling or a confectionery filling.

In one or more embodiments, the edible application product is a chocolate or chocolate-like coating.

In one or more embodiments, the edible application product is a chocolate or chocolate-like moulding.

When describing the embodiments, the combinations and permutations of all possible embodiments have not been explicitly described. Nevertheless, the mere fact that certain measures are recited in mutually different dependent claims or described in different embodiments does not indicate that a combination of these measures cannot be used to advantage. The present invention envisage all possible combinations and permutations of the described embodiments.

The present invention is further illustrated by the following examples, which are not to be construed as limiting the scope of protection.

### EXAMPLES

### Example 1—Vegetable Fat Compositions

A number of vegetable fat compositions based on hydrogenated palm kernel stearin, palm kernel stearin, palm kernel oil, hydrogenated coconut oil and blends thereof are produced by blending the melted liquid component at a temperature of at least 60 degrees Celsius. Table 1 displays the blend composition, the fatty acid composition (FAC), the selected TAG composition as well as the solid fat content (SFC) profile and iodine values (IV) of the vegetable fat compositions.

TABLE 1
Feed compositions, FAC and SFC profiles on vegetable fat compositions.

| | A | | | | | | G | H | I |
|---|---|---|---|---|---|---|---|---|---|
| | (comp) | B | C | D | E | F | (comp) | (comp) | (comp) |
| Vegetable fat | | | | | | | | | |
| composition | | | | | | | | | |
| Hydrogenated | 100.0 | 70.0 | 50.0 | 30.0 | 80.0 | 70.0 | | 80.0 | 70.0 |
| palm kernel | | | | | | | | | |
| stearin (% w/w) | | | | | | | | | |
| Palm kernel | | 30.0 | 50.0 | 70.0 | | | 100.0 | | |
| stearin (% w/w) | | | | | | | | | |
| Palm kernel | | | | | 20.0 | 30.0 | | | |
| oil (% w/w) | | | | | | | | | |
| Hydrogenated | | | | | | | | 20.0 | 30.0 |
| coconut oil | | | | | | | | | |
| (% w/w) | | | | | | | | | |
| Fatty acid | | | | | | | | | |
| composition | | | | | | | | | |
| C6:0 (% w/w) | | | 0.1 | 0.1 | | 0.1 | 0.1 | | |
| C8:0 (% w/w) | 1.9 | 1.9 | 1.9 | 1.9 | 2.2 | 2.4 | 2.0 | 2.9 | 3.4 |
| C10:0 (% w/w) | 2.8 | 2.8 | 2.8 | 2.8 | 2.9 | 2.9 | 2.8 | 3.4 | 3.8 |
| C12:0 (% w/w) | 54.2 | 54.2 | 54.2 | 54.2 | 52.5 | 51.7 | 54.2 | 52.8 | 52.0 |
| C14:0 (% w/w) | 21.7 | 21.7 | 21.7 | 21.7 | 20.6 | 20.0 | 21.7 | 21.2 | 20.9 |
| C16:0 (% w/w) | 9.0 | 9.1 | 9.1 | 9.1 | 9.1 | 9.2 | 9.1 | 9.1 | 9.1 |
| C18:0 (% w/w) | 10.3 | 7.9 | 6.3 | 4.7 | 8.8 | 8.1 | 2.3 | 10.6 | 10.8 |
| C18:1 (% w/w) | | 2.0 | 3.4 | 4.8 | 3.3 | 4.9 | 6.8 | | |
| C18:2 (% w/w) | | 0.3 | 0.5 | 0.7 | 0.5 | 0.8 | 1.0 | | |
| SAFA (% w/w) | 100.0 | 97.7 | 96.1 | 94.5 | 96.2 | 94.3 | 92.2 | 100.0 | 100.0 |
| Selected TAG | | | | | | | | | |
| composition | | | | | | | | | |
| C40:1 | | | | | 0.2 | 0.4 | | | |
| C42:1 | | 0.5 | 0.9 | 1.3 | 1.0 | 1.4 | 1.8 | | |
| C44:1 | | 0.5 | 0.9 | 1.3 | 0.9 | 1.3 | 1.8 | | |
| C46:1 | | 0.5 | 0.8 | 1.1 | 0.9 | 1.4 | 1.6 | | |
| C48:1 | | 0.2 | 0.4 | 0.5 | 0.4 | 0.7 | 0.7 | | |
| C50:1 | | 0.1 | 0.2 | 0.3 | 0.2 | 0.3 | 0.4 | | |
| C52:1 | | | | | 0.1 | 0.1 | | | |
| Sum C40:1 | 0.0 | 1.7 | 3.0 | 4.2 | 3.4 | 5.2 | 5.9 | 0.0 | 0.0 |
| to C48:1 | | | | | | | | | |
| Solid fat | | | | | | | | | |
| content (SFC) | | | | | | | | | |
| SFC (20° C.) | 95.3 | 93.2 | 91.0 | 89.0 | 89.0 | 84.6 | 83.0 | 92.4 | 91.2 |
| SFC (25° C.) | 89.6 | 84.1 | 80.0 | 75.7 | 76.1 | 69.0 | 69.5 | 78.8 | 72.5 |
| SFC (30° C.) | 47.7 | 41.7 | 37.3 | 32.2 | 29.0 | 20.8 | 30.1 | 27.3 | 18.5 |
| SFC (35° C.) | 3.6 | 1.3 | <0.5 | <0.5 | 1.9 | 1.4 | <0.5 | 2.9 | 3.0 |
| SFC (40° C.) | <0.5 | <0.5 | <0.5 | <0.5 | <0.5 | <0.5 | <0.5 | <0.5 | <0.5 |
| IV value | 0.0 | 2.3 | 3.8 | 5.3 | 3.7 | 5.6 | 7.6 | 0.0 | 0.0 |

The fatty acid compositions of the vegetable fat compositions were analyzed using IUPAC 2.301 (Methylation) and IUPAC 2.304 (GLC). The TAG composition were analyzed using ISO 17383. The solid fat content (SFC) was measured according to IUPAC 2.150a. The iodine value (IV) was measured according to IUPAC 2.205.

The blends disclosed in table 1 (B, C, D, E and F) are based on two lauric components. All the blends (B, C, D, E and F) have fully hydrogenated palm kernel stearin (FH PKS IV 7) as one of the components in the blend and then either Palm kernel stearin (PKS IV7) or palm kernel oil (PKO) as the other component. These blends have lower SFC at 20, 25, 30 and 35° C. as compared to FH PKS (FH PKS IV 7) alone. Especially the lower SFC at 35° C. is attractive as it strongly indicates less waxy meltdown as compared to FH PKS (FH PKS IV 7). The entire melt profiles of the blends (B, C, D, E and F) are moving closer to the more attractive melt profile for cocoa butter as compared to the melt profile for FH PKS (FH PKS IV 7).

### Example 2—Recipes and Manufacture of Dark and Milk Chocolate-Like Compounds

Table 2 displays the recipes for the dark and milk chocolate-like compounds.

TABLE 2
Composition of dark and milk chocolate-like compounds.

| | Dark | Milk |
|---|---|---|
| Compound recipes | | |
| Vegetable fat composition (% w/w) | 30.0 | 29.0 |
| Cocoa powder (10-12% CB) (% w/w) | 15.0 | 5.0 |
| Sugar (% w/w) | 48.0 | 47.0 |
| Skim milk powder (% w/w) | 6.0 | 11.0 |
| Whole milk powder (% w/w) | | 7.0 |
| STS (% w/w) | 0.6 | 0.6 |
| Lecithin | 0.4 | 0.4 |
| Total fat content (% w/w) | 31.7 | 31.5 |
| The fat composition distribution in the recipe | | |
| Vegetable fat (% w/w) | 94.6 | 92.1 |
| Cocoa butter (% w/w) | 5.2 | 1.8 |
| Milk fat (% w/w) | 0.2 | 6.1 |

All the ingredients for the dark and milk chocolate-like compounds were mixed in a Hobart N-50 mixer at 65° C. and 55° C. for ten minutes, respectively, and thereafter refined in a Bühler SDY-300 three-roll refiner to a particle size of approximately 20μ. Hereafter, the dark and milk chocolate-like compounds were conched in the Hobart mixer for 6 hours at 65° C. and 55° C., respectively. The compounds were subsequently deposited into 3 g buttons molds and cooled in three zone cooling tunnel for 30 minutes at a temperature of 6° C. for 20 minutes followed by a temperature of 15° C. for 10 minutes.

### Example 3—Sensory Evaluation—Preference Test

The molded buttons were stored at 20° C. for one week. A trained sensory panel evaluated the dark and milk chocolate-like compounds in blind tests to score them in relation to overall taste preference as a combination of hardness, snap, meltdown, waxiness, flavor release, bitterness, and cocoa taste. The samples were given a score of A, B, C, or D, in which the scores correspond to:
A: Excellent overall taste preference
B: Good overall taste preference
C: Acceptable overall taste preference
D: Less the desired overall taste preference

The sensorial score evaluations are illustrated in table 3 and 4 for the dark and milk chocolate-milk compounds, respectively.

TABLE 3
Sensorial scores for dark chocolate-like compounds.

| | | | | | | | | | |
|---|---|---|---|---|---|---|---|---|---|
| Dark | A1 | B1 | C1 | D1 | E1 | F1 | G1 | H1 | I1 |
| compound | (comp) | | | | | | (comp) | (comp) | (comp) |
| Vegetable | A | B | C | D | E | F | G | H | I |
| fat compo- | (comp) | | | | | | (comp) | (comp) | (comp) |
| sition | | | | | | | | | |
| Score. | D | A | B | B | A | B | C | C | D |
| Overall | | | | | | | | | |
| taste | | | | | | | | | |
| preference | | | | | | | | | |

TABLE 4
Sensorial scores for milk compounds.

| | | | | | | | | | |
|---|---|---|---|---|---|---|---|---|---|
| Dark | A2 | B2 | C2 | D2 | E2 | F2 | G2 | H2 | I2 |
| compound | (comp) | | | | | | (comp) | (comp) | (comp) |
| Vegetable | A | B | C | D | E | F | G | H | I |
| fat compo- | (comp) | | | | | | (comp) | (comp) | (comp) |
| sition | | | | | | | | | |
| Score. | D | B | B | B | A | B | C | C | D |
| Overall | | | | | | | | | |
| taste | | | | | | | | | |
| preference | | | | | | | | | |

The sensorial evaluations illustrated in table 3 and 4 for dark and milk chocolate-like compounds, respectively, demonstrate that an improved overall taste preference is obtained for the examples of the invention as B1 to F1 and B2 to F2 all score either A (excellent overall taste preference) or B (good overall taste preference) whereas the comparative examples A1, G1, H1, I1, A2, G2, H2 and 12 score either C (acceptable overall taste preference) or D (less the desired overall taste preference).

The presence of a crystallization seed with a high melting point, such as a high content of fully hydrogenated palm kernel stearin in examples 1 and 2, may result in a waxy afternote for the compound when consumed.

As the focus for the present invention is a CBS with sensory perception closer to chocolate; the reduction in content of a high melting component, such as fully hydrogenated palm kernel stearin, and an increase in content of lower melting components, such as palm kernel oil or fractions thereof (in the examples palm kernel stearin), will result in a more appealing and non-waxy meltdown as is the case for cocoa butter based chocolate.

In addition, the examples of the invention (B1 to F1 and B2 to F2) all have an even surface (backside) when contracted whereas comparative example G (PKS IV 7) is irregular, and warped on the backside surface. Moulded applications based on un-hydrogenated PKS (such as PKS IV 7) tend to contract irregularly during crystallization. For larger sized moulded applications such as tablets, this can result in an uneven backside of the moulded product. This is an undesired feature which producers want to avoid.

1. A vegetable fat composition for edible applications, wherein, in said vegetable fat composition, the:
sum of saturated fatty acids is in the range from 93.0% to 99.0% by weight;
sum of saturated C12:0 fatty acids is in the range from 40.0% to 60.0% by weight;
sum of mono-unsaturated C18:1 fatty acids is in the range from 1.0% to 6.0% by weight; and
sum of mono-unsaturated C40:1 to C48:1 triglycerides is in the range from 1.0% to 5.5% by weight; wherein
the vegetable fat composition consists of fully hydrogenated palm kernel stearin and one other vegetable fat component selected from the group consisting of palm kernel oil, coconut oil, high lauric rapeseed oil, or a blend thereof, and/or fractions thereof.

2. The vegetable fat composition according to claim 1, wherein the vegetable fat composition consists of fully hydrogenated palm kernel stearin and one other vegetable fat component selected from the group consisting of palm kernel oil or a fraction of palm kernel oil.

3. The vegetable fat composition according to any of claim 1, wherein the sum of saturated fatty acids is in the range from 93.5% to 99.0% by weight.

4. The vegetable fat composition according to claim 1, wherein the sum of mono-unsaturated C18:1 fatty acids is in the range from 1.5% to 6.0% by weight.

5. The vegetable fat composition according to claim 1, wherein the sum of mono-unsaturated C40:1 to C48:1 triglycerides is in the range from 1.5% to 5.5% by weight.

6. The vegetable fat composition according to claim 1, wherein the sum of mono-unsaturated C40:1 to C48:1 triglycerides is the sum of monounsaturated C40:1 triglycerides+C42:1 triglycerides+C44:1 triglycerides+C46:1 triglycerides+C48:1 triglycerides.

7. The vegetable fat composition according to claim 1, wherein the iodine value (IV) of the vegetable fat composition is in the range from 1.0 to 6.5.

8. The vegetable fat composition according to claim 1, wherein the fraction of palm kernel oil is palm kernel stearin.

9. The vegetable fat composition according to claim 1, wherein the vegetable fat component originates from naturally occurring vegetable fats.

10. The vegetable fat composition according to claim 1, wherein the vegetable fat composition is a Cocoa Butter Substitute.

11. The vegetable fat composition according to claim 1, wherein the vegetable fat composition is used in coating or enrobing for bakery, confectionery, and/or moulding applications.

12. The vegetable fat composition according to claim 1, wherein the vegetable fat composition is used in fillings.

13. An edible application product comprising the vegetable fat composition according to claim 1.

14. The edible application product according to claim 13, wherein the edible application product is a bakery product; a dairy product; a chocolate- and/or a chocolate-like product; a coating or enrobing product; or a filling product.

15. The vegetable fat composition according to claim 11, wherein the vegetable fat composition is used in chocolate and chocolate-like coatings.

16. The vegetable fat composition according to claim 12, wherein the vegetable fat composition is used in bakery fillings and confectionary fillings.

17. The edible application product according to claim 14, wherein the edible application product is a coating or enrobing product for bakery, confectionery, or moulding applications.

18. The edible application product according to claim 14, wherein the edible application product is a coating or enrobing product for bakery, confectionery, and moulding applications.

19. The edible application product according to claim 14, wherein the edible application product is a bakery filling or a confectionery filling product.

20. The edible application product according to claim 14, wherein the edible application product is a chocolate or chocolate-like coating product.
